(19) United States
(12) Patent Application Publication
(10) Pub. No.: US 2023/0356793 A1
(43) Pub. Date: Nov. 9, 2023

(54) A LINKAGE UNIT FOR A ROLLER CHAIN LINK ASSEMBLY SUITABLE FOR USE IN A CATERPILLAR TRACK

(71) Applicant: EIK Engineering Sdn. Bhd., Iskandar Puteri (MY)

(72) Inventor: Kim Boon Tiew, Iskandar Puteri (MY)

(73) Assignee: EIK Engineering Sdn. Bhd., Iskander Puteri (MY)

(21) Appl. No.: 18/025,835

(22) PCT Filed: Dec. 22, 2020
(86) PCT No.: PCT/MY20/50201

§ 371 Date: Mar. 10, 2023

(30) Foreign Application Priority Data
Sep. 15, 2020 (MY) PI 2020004776

(51) Int. Cl. B62D 55/21; F16C 19/46; F16C 33/76

(52) U.S. Cl. CPC B62D 55/21; F16C 19/46; F16C 33/76

(57) ABSTRACT

The present invention relates to a linkage unit (101) for a roller chain link assembly of a caterpillar track, the unit comprising a bushing (102) which has a body and a seat (103) retaining a sealing member (104) at each of the respective axial ends of the body, an outer roller (105) mounted on the bushing (102) for rotation relative to the bushing (102) and means for reducing friction (106) disposed between the internal surface of the outer roller (105) and the outer surface of the bushing (102). The present invention also relates to a roller chain link assembly (110) having the aforementioned linkage unit (101) and a caterpillar track (301) suitable for use in track-type machines employing the roller chain link assembly (110).

### FIELD OF INVENTION

The present invention relates to a linkage unit. Particularly, the present invention relates to a linkage unit to be assembled in a roller chain link assembly suitable for use in a caterpillar track.

### BACKGROUND OF THE INVENTION

Some link assemblies employed on track-type machines such as ditching machines, earth scraping vehicles and excavators include a pair of parallel track chain, which include a plurality of links that are interconnected by laterally disposed pins. These machines are often involved in abrasive environments, therefore it has been desirable to protect and safeguard the chain bushings by keeping the bushing and pin lubricated, at the same time preventing abrasive material from entering the bushing or pin surfaces. In practice, a bushing is disposed in the hollow portion of a provided roller such that the bushing may rotate relative to the roller therein. Since a roller chain is adapted for use in track-type machines, exposure to atmosphere of dust, water or the like is inevitable. As such, a sealing mechanism is common provided between a chain link plate and a roller having a bushing disposed therein to prevent invasion or entry of foreign material between the roller and the bushing which rotatably supports the roller and to further prevent the leakage of grease or oil preferably sealed between the roller and the bushing.

FIG. 3 shows a perspective view of a conventional roller and bushing unit 201 in a roller chain link assembly. A roller 202 provides outward flanges 203 on both axial ends and a bushing 205 is strategically disposed in the hollow portion thereof. Conventionally, a lubricant may be provided in the space or gap between an internal surface 204 of the roller 202 and the outer surface of the bushing 205 to form a lubricating layer. It is noted a chain link plate 206 having an aperture 207 is disposed at the axial end of the roller and bushing unit 201 and a connecting pin operatively brought to extend through the aperture of the chain link plate and the roller and bushing unit thereby realising a roller chain link assembly. In the aforementioned conventional roller and bushing unit for a roller chain link assembly, a sealing mechanism may be provided between the roller and the link plate if required during installation. Essentially, the conventional configuration of the above said roller and bushing unit is not sufficient in terms of its rotation performance. The sealing mechanism is commonly comprised of an annular seal which is configured to be in close contact with the roller or the link plate, however merely being in close contact does not ensure securement of the sealing mechanism in place. Lubricating oil can leak out of any space or gap between and end surface of the roller and the sealing mechanism provided that the sealing performance is relatively not sufficient due to low close contact with the roller, for example, the sealing mechanism may simply slip out of place during abrasive and harsh operation of the track-type machines, thereby leaving the space or gap for the leakage to occur. Furthermore, a problem can arise such that foreign matter such as unwanted dust, water or the like enters through the space or gap and bound to mix with the lubricating oil thereby causing wear and tear of the roller and bushing, resulting in failure of the roller's rotation produced by the wear. Conventionally, the internal surface of the roller is substantially smooth which lacks a channel for retaining the lubricating oil therein. In such circumstance, a confronting pressure between the excessive lubricating oil and the roller and bushing unit can forcibly induce leakage of the oil from the lubricating layer between the roller and the bushing.

As such, there is a need to provide a roller and bushing unit for a roller chain link assembly suitable for a track-type machine, particularly having a mechanism which is able to reduce frictional contact between the roller and the bushing, thereby enhancing the feasibility of the roller and bushing unit during heavy duty usage. This invention provides such a solution.

### SUMMARY OF INVENTION

One aspect of the invention is to provide a linkage unit for a roller chain link assembly suitable to be employed in a caterpillar track-type machine. Advantageously, the linkage unit is comprised of a roller having means for reducing friction that is strategically disposed in the internal surface of the roller and the outer surface of the bushing when the bushing is being journaled into the hollow portion of the roller.

Another aspect of the invention is to provide a roller chain link assembly suitable to be employed in a caterpillar track-type machine. Basically, a pair of the aforementioned linkage units are being connected together at each opposite ends of a pair of sidebar portions to thereby realising a roller chain joint. Advantageously, the roller chain link assembly is resistant to harsh and abrasive environments due to the appending features inherited from the aforementioned linkage unit.

Still in another aspect, the invention relates to a caterpillar track suitable for a track-type machine that utilises the aforementioned roller chain link assembly comprised of the linkage unit as aforementioned.

At least one of the preceding objects is met, in whole or in part, in which the embodiment of the present invention describes a linkage unit for a roller chain link assembly of a caterpillar track, the unit comprising a bushing which has a body and a seat retaining a sealing member at each of the respective axial ends of the body, an outer roller mounted on the bushing for rotation relative to the bushing and means for reducing friction disposed between the internal surface of the outer roller and the outer surface of the bushing.

In a preferred embodiment of the invention, it is disclosed that the friction-reducing means comprises a plurality of inner rollers being arranged axially along the axial length and radially around the internal surface of the outer roller.

In another preferred embodiment of the invention, it is disclosed that each of the plurality of inner rollers is configured to roll independently about an axis corresponding to the outer roller while being in contact with the outer surface of the bushing.

Further embodiment of the present invention discloses that the internal surface of the outer roller has means provided therein for carrying lubricant along the axial length of the unit thereby forming a lubricating layer between the internal surface of the outer roller and the outer surface of the friction-reducing means.

Preferably, the means for carrying lubricant comprises a continuous spiral or helical groove extending axially along the internal surface of the outer roller.

Preferably, the means for carrying lubricant comprises a smooth surface extending axially along the internal surface of the outer roller.

More preferably, the sealing member is configured to dispose on each axial ends of the body of the bushing for minimizing egress of lubricant from the unit and ingress of foreign matter into the unit.

Even more preferably, the sealing member is an annular seal.

It is preferred that the outer roller has an outward recess at each respective axial end.

It is also preferred that the outer roller has a hollow portion of which the bushing is rotatably journaled therein.

A preferred embodiment of the invention also describes a roller chain link assembly suitable for a caterpillar track, the assembly comprising a pair of sidebar portions, each side portion has opposite ends, a pair of linkage units, each unit having axial ends and comprising a bushing which has a body and a seat retaining a sealing member at each of the respective axial ends of the body, an outer roller mounted on the bushing for rotation relative to the bushing, and means for connecting the opposite ends of the sidebar portion to the axial ends of the linkage unit to form a chain joint, the outer roller has an internal surface having means provided therein for carrying lubricant along the axial length of the unit thereby forming a lubricating layer between the internal surface of the outer roller and the outer surface of the bushing, characterized in that the assembly further comprises means for reducing friction disposed between the internal surface of the outer roller and the outer surface of the bushing. Particularly, the friction-reducing means comprises a plurality of inner rollers being arranged axially along the axial length and radially around the internal surface of the outer roller.

Another preferred embodiment of the invention describes a caterpillar track comprising a plurality of roller chain link assemblies, a plurality of elongated beams having a body and more than one support frame provided thereon in a spaced-apart manner, each support frame supporting each roller chain link assembly whereby each elongated beam being pivotally hinged to a neighbouring elongated beam by a respective roller chain link assembly, thereby forming an endless chain track, wherein the roller chain link assembly comprises a pair of sidebar portions, each side portion has opposite ends, a pair of linkage units, each unit having axial ends and comprising a bushing which has a body and a seat retaining a sealing member at each of the respective axial ends of the body, an outer roller mounted on the bushing for rotation relative to the bushing, and means for connecting the opposite ends of the sidebar portion to the axial ends of the linkage unit to form a chain joint, the outer roller has an internal surface having means provided therein for carrying lubricant along the axial length of the unit thereby forming a lubricating layer between the internal surface of the roller and the outer surface of the bushing, characterized in that the assembly further comprises means for reducing friction disposed between the internal surface of the outer roller and the outer surface of the bushing. Particularly, the friction-reducing means comprises a plurality of inner rollers being arranged axially along the axial length and radially around the internal surface of the outer roller.

One skilled in the art will readily appreciate that the present invention is well adapted to carry out the objects and obtain the ends and advantages mentioned, as well as those inherent therein. The embodiment described herein is not intended as limitations on the scope of the invention.

### BRIEF DESCRIPTION OF THE DRAWINGS

For the purpose of facilitating an understanding of the invention, there is illustrated in the accompanying drawing the preferred embodiments from an inspection of which when considered in connection with the following description, the invention, its construction and operation and many of its advantages would be readily understood and appreciated.

FIG. 1 illustrates a perspective view of a linkage unit according to the present invention.

FIG. 2 illustrates a cross-sectional view of a linkage unit according to the present invention.

FIG. 3 illustrates a conventional roller and bushing unit employed in a roller chain link assembly.

FIG. 4 illustrates a preferred embodiment of a roller chain link assembly in a caterpillar track embodying the linkage unit according to the present invention.

FIG. 5 illustrates an exemplary track-type machine employing the caterpillar track according to the present invention.

### DETAILED DESCRIPTION OF THE INVENTION

Hereinafter, the invention shall be described according to the preferred embodiments of the present invention and by referring to the accompanying description and drawings. However, it is to be understood that limiting the description to the preferred embodiments of the invention is merely to facilitate discussion of the present invention and it is envisioned that those skilled in the art may devise various modifications without departing from the scope of the appended claim.

The invention will now be described in greater detail with reference to the drawings.

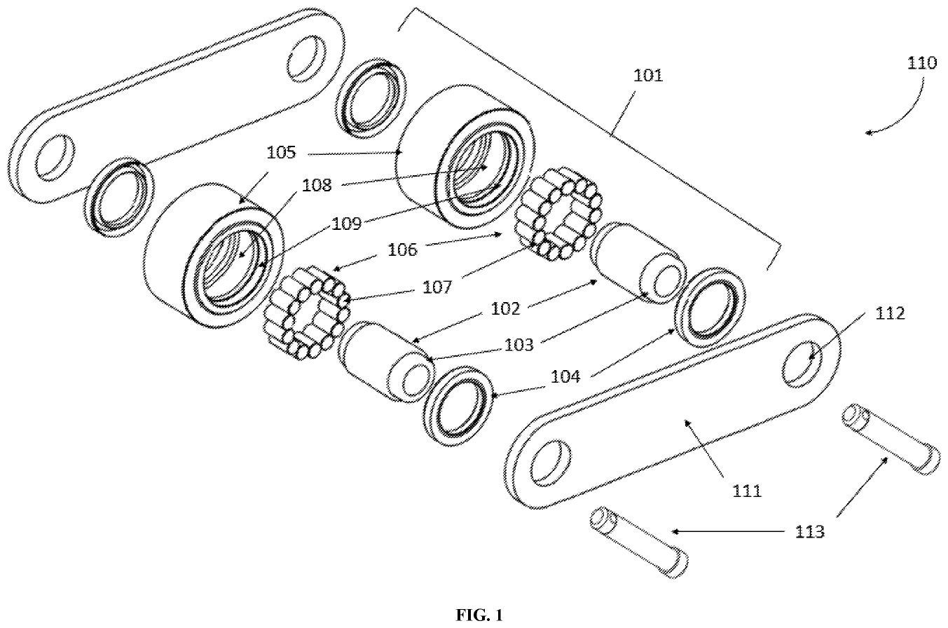

FIG. 1 illustrates an exemplary linkage unit 101 that is suitable to be assembled into a roller chain link for use in a caterpillar track-type machine. By way of example, the caterpillar track-type machine may include but not limited to a loader, an excavator, a tractor, a tank, an amphibious vehicle or any other mobile machine having caterpillar track-type traction devices. The linkage unit 101 essentially comprises a bushing 102 having a tubular body with opposite axial ends, an internal surface having an internal diameter and an external surface having an external diameter. A seat 103 is provided at each axial ends of the bushing 102. It is to be noted that the annular dimension of the seat 103 may be diametrically smaller than the tubular body of the bushing 102. Alternatively, the annular dimension of the seat 103 may also be of the same dimension as the tubular body of the bushing 102. Nevertheless, the annular dimension differences between the seat 103 and the tubular body of the bushing 102 do not limit the configuration of the linkage unit 101 and merely a possible exemplification.

Accordingly, the linkage unit 101 further comprises an outer roller 105; preferably the outer roller 105 has a tubular body with axial ends. As exemplified in FIG. 1, the roller 105 has a hollow portion extending therealong the body with an internal surface having an internal diameter and an external surface having an external diameter. As such, the outer roller 105 is preferably mounted on the bushing 102 for rotation relative to the bushing 102 which is journaled concentrically within the hollow portion of the outer roller 105. In a stricter perspective for example, the roller 105 functions as a protectant for the bushing 102, therefore it is preferable that the outer roller 105 is constructed seamlessly, which may be enhanced in mechanical strength by carburization hardening or any other suitable metal hardening techniques known in the art as compared with a roller used for a normal roller chain linkage unit. It is also desirable to strengthen the outer roller 105 of the linkage unit 101 in abrasive resistance by enhancing surface hardness so that the outer roller 105 can resist the harsh and abrasive environments.

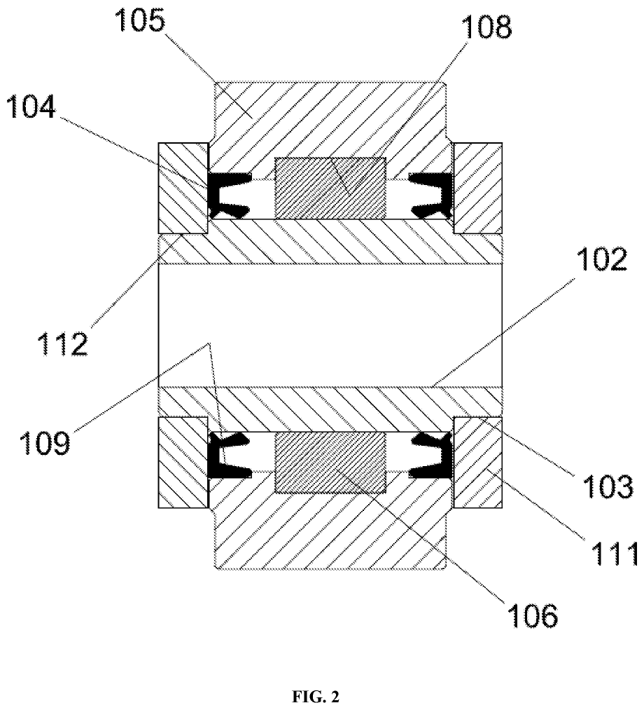

As seen in FIG. 2 depicting a cross-sectional view of the linkage unit 101, there is an annular clearance zone particularly configured and reserved to accommodate means for reducing friction 106 which is disposed between the internal surface of the outer roller 105 and the outer surface of the bushing 102. As exemplified in FIG. 1, the friction-reducing means 106 preferably comprises a plurality of inner rollers 107 being arranged axially along the axial length and radially around the internal surface of the outer roller 105. Essentially, the inner rollers 107 are diametrically smaller than the hollow portion of the outer roller 105 so as to be accommodated therein. It is to be appreciated that the inner rollers 107 enhanced in mechanical strength by ways of carburization hardening or any other suitable metal hardening techniques as aforementioned. As the name implies, the inner rollers 107 of the friction-reducing means 106 are provided for reducing frictional contact between the internal surface of the outer roller 105 and the outer surface of the bushing 102. In other words, the inner rollers 107 function as a barrier therebetween to prevent wear and tear damages in the linkage unit 101 thereby eliminating the frictional contact between the internal surface of the outer roller 105 and the outer surface of the bushing 102. As such, a preferred embodiment of the present invention recites that each of the plurality of inner rollers 107 is configured to roll independently about an axis corresponding to the outer roller 105 while being in contact with the outer surface of the bushing 102.

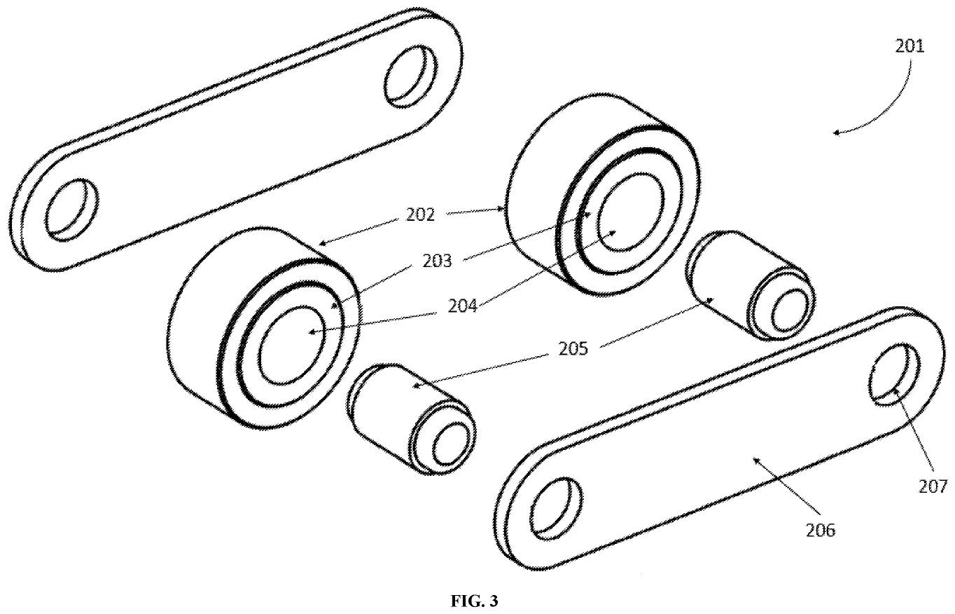

Conventionally, a lubricant may be provided in the space or gap between an internal surface 204 of the roller 202 and the outer surface of the bushing 205 in a conventional roller and bushing unit 201 to form a lubricating layer, as depicted in FIG. 3. The lubricating layer may not be effectively retained as a confronting pressure between the roller 202 and the bushing 205 may cause leakage or egress of lubricant from the conventional roller and bushing unit 201. To ensure prevention of leakage or egress of lubricant from the linkage unit 101, the internal surface of the outer roller 105 employed in the linkage unit 101 of the present invention has means for carrying lubricant 108 provided therein for carrying a lubricant such as oil, grease or the like thereby forming a sufficient lubricating layer therewithin. Particularly, the lubricating layer is formed between the internal surface of the outer roller 105 and the outer surface of the friction-reducing means 106.

Preferably, the means for carrying lubricant 108 comprises a continuous spiral or helical groove extending axially along the internal surface of the outer roller 105. Advantageously, the means for carrying lubricant 108 featuring a continuous spiral or helical groove can effectively form a channel for retaining lubricant therein so that the lubricating performance of the linkage unit 101 is enhanced. Essentially, the means for carrying lubricant 108 allows substantially permanent retention or containment of lubricant within the groove so that the linkage unit 101 does not require frequent maintenance and repair. Furthermore, such continuous spiral or helical configuration of the means for carrying lubricant 108 can render the loss or leakage of excessive lubricant from the linkage unit 101 negligible.

In another preferred embodiment, the means for carrying lubricant 108 may comprise a smooth surface extending axially along the internal surface of the outer roller 105. Such smooth surface configuration on the internal surface of the outer roller 105 may be favoured if the linkage unit 101 is to be subjected to harsher environment so that wear and tear of the external surface of the bushing 102 caused by frequent impact, for example by the grooved surface configuration of the internal surface of the outer roller 105. An exemplary illustration of the smooth surface configuration on the internal surface of the roller 105 can be viewed in FIG. 1. It is an added advantage that the lubricant from the lubricant-carrying means 108 may flow and channel through the inner rollers 107 of the friction-reducing means 106. In this way, substantial lubricating layer may be extended throughout the linkage unit 101.

According to an embodiment of the invention, the outer roller 105 preferably has an inwards recess 109 provided at each respective axial ends of the body of the outer roller 105. As aforementioned, the bushing 102 of the linkage unit 101 has a seat 103 provided at each axial ends of the body of the bushing 102. For example, the dimension of the inwards recess 109 of the outer roller 105 may be diametrically larger than the seat 103 of the bushing 102. Essentially, a sealing member 104 is provided on each of the respective axial ends of the body of the bushing 102 for sealing the annular clearance zone formed between the internal surface of the roller 105 and the external surface of the bushing 102.

It is to be appreciated that the sealing member 104 is configured to dispose on each axial ends of the body of the bushing 102. By way of example, upon installation of the sealing member 104 onto the axial ends of the body of the bushing 102 and then further journaled concentrically within the hollow portion of the outer roller 105, the sealing member 104 may fittingly or snuggly engage the inwards recess 109 of the outer roller 105. As a result, an interlocking structure may be formed for enhancing the sealing performance of the sealing member 104.

According to an embodiment of the invention, the sealing member 104 is preferably an annular seal. For example, the sealing member 104 may be made of elastomeric material having flexible resiliency. In actuality, the positioning of the sealing member 104 on each axial ends of the bodyof the bushing 102 whilst engaging the inwards recess 109 of the roller 105 presents a technical advantage such that the bushing 102 is held in place to be positioned concentrically with the centre of the hollow portion of the roller 105 by the resiliency and elasticity of the sealing member 104. Advantageously, the resiliency and elasticity of the sealing member 104 can effectively absorb unforgiving external force or impact on the linkage unit 101. As such, in this state in which external force or impact is not exerted directly on the linkage unit 101, the annular clearance zone between the internal surface of the outer roller 105 and the friction-reducing means 106 while in contact with the external surface of the bushing 102 is uniformly maintained in a circumferential direction. As a result, the lubricant applied therein moves and channels within the means for carrying lubricant 108 disposed in the internal surface of the outer roller 105 thereby forming an overall effective lubricating layer. It is of a particular advantage of the present invention that the sealing member 104 effectively minimizes egress of lubricant from the linkage unit 101 and ingress of foreign matter such as dust, water or the like into the linkage unit 101. As an alternative, the sealing member 104 may be configured to be substantially rigid and fixed to the axial ends of the body of the bushing 102 thereby can be adapted to act as an abutment element.

A preferred embodiment of the invention also describes a roller chain link assembly 110 suitable to be employed in a caterpillar track as exemplified in FIG. 1. Basically, the roller chain link assembly 110 comprises a pair of sidebar portions 111 and a pair of the linkage units 101 as aforementioned. As seen in FIG. 1, the sidebar portions 111 are arranged in an opposing and aligned manner, and preferably the linkage units 101 are sandwiched in between the pair of sidebar portions 111. Each sidebar portion 111 is an integral piece having opposite ends whereby each opposite end is disposed an aperture 112. By way of example, two linkage units 101 are supported by or secured to a pair of sidebar portions 111 such that each linkage unit 101 is supported by one pair of the sidebar portions 111 and extends through the apertures 112 of the sidebar portions 111 and such that the seat 103 of the bushing 102 respectively projects beyond the apertures 112 of the sidebar portions 111. Alternatively, the seat 103 of the bushing 102 may be configured to fittingly or snuggly secured in the apertures 112 of the sidebar portions 111. Making reference back to FIG. 1, the sealing member 104 as seated on each axial ends of the bodyl03 of the bushing 102 assists in the assembly of the roller chain link assembly 111 such that the lip portion 109 of the sealing member 104 may be configured in close contact with the peripheral surface of the sidebar portions 111 as the seat 103 of the bushing 102 are brought to project through the apertures 112 of the sidebar portions 111. Accordingly, the sealing member 104 may act as a gap filler between the bushing 102 and the sidebar portion 111 so as to prevent a circumstance of wear and tear in the case the bushing 102 and the sidebar portion 111 confront each other during harsh and abrasive movements of the roller chain link assembly 110. It is of an added advantage that the sealing member 104 is made of an elastomeric material having flexible resiliency and flexibility so that external force and impact to the roller chain link assembly 110 can be absorbed.

According to a preferred embodiment, means for connecting 113 the sidebar portions 111 with the linkage unit 101 is preferably provided in order to realise the roller chain link assembly 110. By way of example, a pair of connecting means 113 having opposite ends are extended through a pair of the linkage units 101 and the opposite ends of the connecting means 113 are respectively housed in each of the apertures 112 of the opposing sidebar portions 111 adjacent to the axial ends of the linkage units 101 thereby realising a roller chain link assembly 110. For example, the connecting means 113 may be a tubular bar as exemplified in FIG. 1.

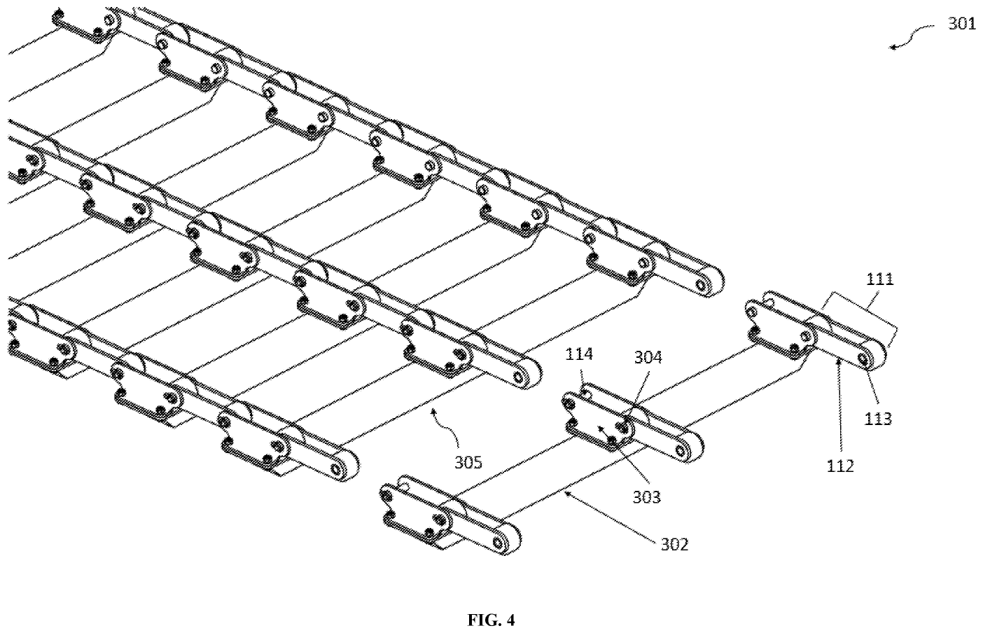

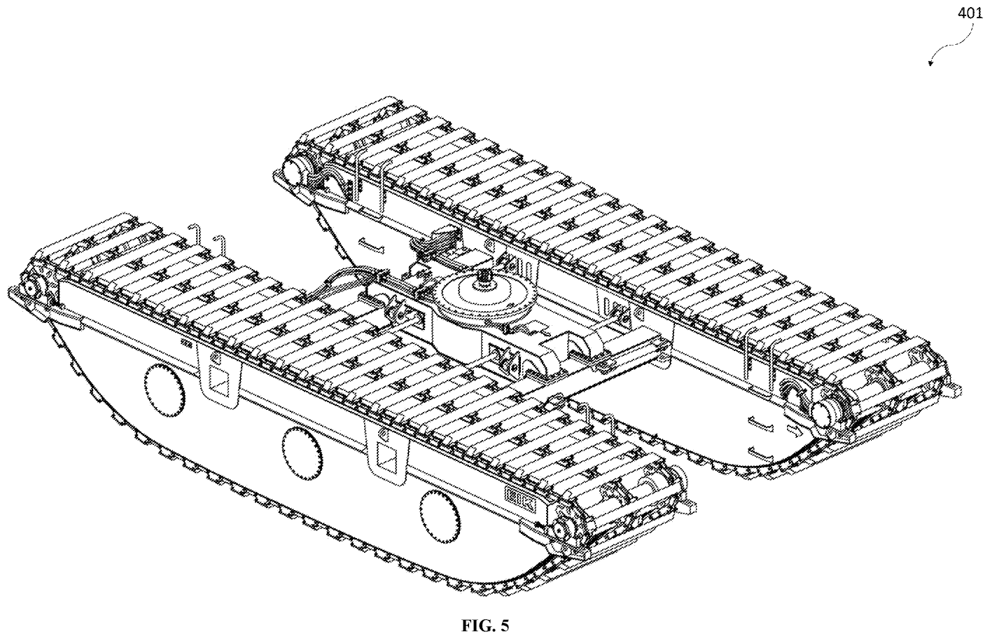

In another preferred embodiment of the invention, there is also provided an exemplary caterpillar track 301 suitable to be employed in any caterpillar track-type machines. As inferred in FIG. 4, the caterpillar track 301 is constructed by providing an elongated beam 302 having a body for disposing more than one roller chain link assembly 110 thereon in a spaced-apart manner. In the context of the invention, the elongated beam 302 forms a traction element of the caterpillar track 301. Preferably, the body of the elongated beam 302 is fixedly provided with more than one support frame 303. For example, the support frame 303 may be configured to have a bore 304 at each opposite ends thereof and one opposite end of the roller chain link assembly 110 may be connected together by extending the connecting means 113 through the bore 304 of the support frame 303 with the aperture 112 of the sidebar portion 111 and the roller chain link assembly 110. Essentially, a neighbouring elongated beam 302 having the attached roller chain link assembly 110 supported by the support frame 303 is preferably provided and each respective ends of each roller chain link assembly 110 is pivotally hinged to the opposing roller chain link assembly 110 provided on the elongated beam 302 by the connecting means 113, thereby forming an endless chain track 305 of a caterpillar track. An exemplary amphibious vehicle 401 employing the caterpillar track 301 is illustrated in FIG. 5.

The present disclosure includes as contained in the appended claims, as well as that of the foregoing description. Although this invention has been described in its preferred form with a degree of particularly, it is understood that the present disclosure of the preferred form has been made only by way of example and that numerous changes in the details of construction and the combination and arrangements of parts may be resorted to without departing from the scope of the invention.

1.-12. (canceled)

13. A linkage unit for a roller chain link assembly of a caterpillar track, comprising:
a bushing which has a body and a seat retaining a sidebar portion at each of the respective axial ends of the body;
an outer roller mounted on the bushing for rotation relative to the bushing;
means for reducing friction disposed between an internal surface of the outer roller and an outer surface of the bushing; and
a sealing member disposed on each axial end of the body of the bushing;
wherein the internal surface of the outer roller has means for carrying lubricant provided therein for carrying lubricant along the axial length of the unit thereby forming a lubricating layer between the internal surface of the outer roller and the outer surface of the friction-reducing means;
wherein the means for carrying lubricant is in a form of an annual groove positioned at generally center of the inner surface of the outer roller for containing the means for reducing friction and the means for carrying lubricant comprises a pair of extended walls to engage with opposing sides of the means for reducing friction such that the means for reducing friction is retained in position by the groove, and the extended walls further separate the means for reducing friction and the sealing member with a gap formed therebetween;
wherein the friction-reducing means comprises a plurality of inner rollers formed as a single row and being arranged axially along the axial length and radially around the internal surface of the outer roller.

14. The linkage unit according to claim 13, wherein each of the plurality of inner rollers is configured to roll independently about an axis corresponding to the outer roller while being in contact with the outer surface of the bushing.

15. The linkage unit according to claim 14, wherein the means for carrying lubricant comprises a continuous spiral or helical groove extending axially along the internal surface of the outer roller.

16. The linkage unit according to claim 14, wherein the means for carrying lubricant comprises a smooth surface extending axially along the internal surface of the outer roller.

17. The linkage unit according to claim 13, wherein the sealing member is configured to dispose on each axial ends of the body of the bushing for minimizing egress of lubricant from the unit and ingress of foreign matter into the unit.

18. The linkage unit according to claim 17, wherein the sealing member is an annular seal.

19. The linkage unit according to claim 13, wherein the outer roller has an inwards recess at each respective axial end.

20. The linkage unit according to claim 19, wherein the outer roller has a hollow portion of which the bushing is rotatably journaled therein.

21. A roller chain link assembly suitable for a caterpillar track having a linkage unit according claim 13.

22. A caterpillar track having a roller chain link assembly according to claim 21.
